(19) United States
(12) Patent Application Publication
(10) Pub. No.: US 2002/0123592 A1
(43) Pub. Date: Sep. 5, 2002

(54) Organic-inorganic hybrids surface adhesion promoter

(75) Inventors: Zhiyi Zhang, Ottawa (CA); Gaozhi Xiao, Ottawa (CA)

Correspondence Address: FRIEDRICH KUEFFNER, SUITE 1921, 342 MADISON AVENUE, NEW YORK, NY, 10173, US

(73) Assignee: Zenastra Photonics Inc.

(21) Appl. No.: 09/798,519

(22) Filed: Mar. 2, 2001

(51) Int. Cl. C08G 77/00

(52) U.S. Cl. 528/10

(57) ABSTRACT

An organic-inorganic hybrid surface adhesion promoter having the general formula, A-B, wherein A is hydrolyzed and polycondensed from a trioxysilane R-Si(OR′)₃ or its mixture with one or two more silanes, where R′ is methyl, ethyl or propyl, and where R is an organic group of methacrylate, epoxy, amine, isolyante, hydroxide or non-halogens or halogens containing alkyl, alkenyl, aryl, alkylary or arylalky, and wherein B is hydrolyzed and polycondensed from an alkoxy silane, chloride silane, or alkoxy or chloride metal compound, whereby B reacts with a substrate to form a uniting group which is selected from the group consisting of Si—O—Si, M-O-M, M-O—S and Si—O-M, M being a metal atom.

### BACKGROUND OF INNENTION

1. Field of the Invention

This invention relates to an organic-inorganic hybrid surface adhesion promoter and two-step processes for their preparation.

This organic-inorganic hybrid surface adhesion promoter is particularly suited for application in improving the processing and promoting adhesion of organic materials on silicon, glass, ceramic, and metal, especially, in the fabrication of high quality organic waveguides.

2. Description of the Prior Art

Processability and interfacial adhesion are two important issues when an organic material, whether as coating, adhesives or bulk, is applied onto an inorganic substrate. Processability is directly related to organic material's nature and is significantly affected by the substrate surface. Wettability and spreading are, for instance, two substrate-related processing issues. Only when the substrate surface energy is matched with the material to be applied, can good wetting and spreading, which are essential for coating quality, for example, be achieved for the material. Interfacial adhesion is dependent on the surface energy matching and chemical bonds between the organic materials and inorganic substrate. While a good matching in surface energy can enhance the interfacial adhesion by physical force (i.e. Van der Waals force), chemical bonds directly provide strong inter-chemical connection between different materials.

Ideally, the organic material or the inorganic substrate can be modified chemically to satisfy the requirement in processability and interfacial adhesion. In many cases, such chemical modification is not allowed and a surface treatment agent, coupling agent, or adhesion promoter is used to help the processing and interfacial adhesion. These promoters are usually small molecules based. Typical commercial chemicals for treating glass substrate are silanes, e.g γ-aminopropyl triethoxysilane and γ-methacryloxypropyl-trimethoxysilane. One end of these promoters can chemically react with glass while another end has a strong physical interaction or even chemical reaction with the organic materials to be applied on top. Most of the glass and carbon fibres used for manufacturing fibre/polymer composites, are, for instance, coated with some small molecular surface adhesion promoters. HMDS (1, 1, 1, 3, 3, 3-Hexamethyldisilazane) is widely used in treating silica wafers before coating photo-resist in semiconductor industry.

While small molecular surface adhesion promoters have been widely used in various applications, e.g. fibre/polymer composites, macromolecular surface adhesion promoters are seldom used. Macromolecular surface adhesion promoters, in fact, have many advantages. First of all, macromolecular ones have a good coverage on the substrate because a relative thick layer of the macromolecules can be easily deposited on substrate. This is important in guaranteeing the quality in treating a large substrate surface. Secondly, in addition to adhesion promotion, they can act as a stress relaxation interfacial layer which is useful in damping impact energy and avoid crack propagation in the top materials and even substrates. In this case, the promoters should have short intrinsic molecular relaxation time and should usually have low glass transition temperature (Tg). It is well accepted that an interface with strong interfacial bonding and a tough interfacial layer is the idea interface in fibre or particulate reinforced composites. Also, macromolecular surface adhesion promoters can also act as expansion transition layer between substrate and the organic materials to be applied on top. If the thermal expansion between the organic materials and substrate is mismatched, a stress which could develop in the materials and cause cracks in the materials can develop. For instance, when a UV curable sol-gel coating is deposited on silica for fabrication waveguides, the coating can easily develop cracking when it is heated to 130 to 170° C. for curing. The coefficient of thermal expansion (CTE) is around 10×10⁻⁶ for sol-gel and 5.5×10⁻⁷ for silica and is substantially mismatched between the two materials. A layer of ductile surface adhesion promoter which has similar CTE with the sol-gel coating will be able to reduce the thermal stress in the coating.

In comparison with small molecular ones, macromolecular surface adhesion promoters have some disadvantages, including, the difficulty in structure design and synthesis, strong selection to the materials, and high requirement in processing. Macromolecules have more complicated structure than small molecules do. There are first order, second order, and even third order structure for macromolecules and only first order structure for small molecules, which brings a lot difficulty in designing and synthesizing macromolecular promoters. Also, due to their long molecular chains, there is a compatibility issue at their interface with the top materials and the rheology of the macromolecules is related to their molecular weight as well as molecular texture.

It is well-known that metal alkoxides could be hydrolyzed and condensed to form glasses. It was also known that silica could be produced in-situ as a chemical of compounds e.g., tetraethylorthosilicate (TEOS). It was also known partially to hydrolyze silicon alkoxide with acid and metal oxide to prepare a glass precursor which could be fired to a glass composition at a temperature of above 1000 degree. The prior art also described the preparation of clear alcohol solution of acid hydrolyzed metal alkoxide which can be coated on the substrate and dried to produce an optical coating. Silane coupling agents are also known to provide a useful means to crosslink organic and inorganic surfaces and particles.

The “sol-gel” method provides a teaching that the condensation of reactive metal oxide monomers can occur in the liquid phase at temperatures in the range of 25.degree.- 60.degree. C. The sol-gel reaction is a two-step process during which metal alkoxides are hydrolyzed to form metal hydroxides, which in turn condense to form a three-dimensional network.

The sol-gel method allows the formation of hybrid composite materials made of inorganic (glass) and organic components which would not survive the very high temperatures of traditional glass making methods. Such a composite material can provide advantages resulting from the combination of the tensile strength and impact resistance of the organic polymer and the compressive of strength of the inorganic matrix. The introduction of organic groups into glass can thus provide variations in properties such as strength, toughness, stiffness, brittleness, hardness, homogeneity, density, free volume, and thermal stability. Secondary considerations include resistance to corrosion, creep, and moisture. Both the strength and stiffness of a composite can be derived from the properties of the reinforcing fiber. Toughness results from the interaction between the matrix and fibers. Such composite materials may be used in the manufacture of piezoelectric, ferroelectric, electro-optic, and superconducting fibers and films.

Organic-inorganic hybrids have recently attracted substantial attention due to the potential of combining distinct properties of organic and inorganic components within a single molecular composite.

There is a need for simple and inexpensive thin film deposition techniques. One of the key difficulties depositing thin films of organic-inorganic hybrids is the distinctly different character of the organic and inorganic components with regard to potential film forming processes. Organic materials tend to be soluble in solvents which are not, in general, the same as those appropriate for the inorganic component, making it's often impractical to find a suitable solvent to enable the solution deposition techniques (e.g. spin-coating). Additionally, organic compounds tend to decompose at relatively low temperature, where as inorganic materials often do not effectively evaporate until much higher temperatures.

U.S. Pat. No. 5,120,811 issued Jun. 9, 1992 to Glotfeller et al. provided a polymer/glass hybrid coating consisting essentially the reaction product of an acid-catalyzed hydrolysis product of a metal alkoxide selected from the group consisting of tetramethylorthosilicate, tetraethylorthosilicate and tetrapropylorthosilicate, and an acid-catalyzed hydrolysis product of a coupling agent having a metal alkoxide functionality and inorganic functionality, the organic functionality of the coupling agent being selected from the group consisting of acrylic, methaylic and epoxy moieties.

U.S. Pat. No. 5,178,675 issued Jan. 12, 1993 to Sexsmith provided on adhesive composition useful for bonding various substrates which contain alkoxy silane compound and an unsatutated acid compound. A preferred embodiment of the invention is an aqueous formulation containing a low molecular weight alkoxy silane compound, a low molecular weight unsaturated acid compound, and water. An example alkoxy silane compound is aminopropyl triethoxysilane while an example of the unsaturated acid compound is methacrylate acid The adhesives composition is particularly effective in bonding non-sulfurcured elastomeric materials such as polyol- and peroxide-cured elastomers to metal surfaces. That product is an adhesive composition useful for bonding various substrates which contain an alkoxy silane compound and an unsaturated acid compound. A preferred embodiment is an aqueous formulation containing a low molecular weight alkoxy silane compound, a low molecular weight unsaturated acid compound, and water. An example of alkoxy silane compound is aminopropyl triethoxysilane while an example of the unsaturated acid compounds is methacrylic acid. The adhesive composition is particularly effective in bonding non-sulfurcured elastomeric materials such as polyol- and peroxide-cured elastomers to metal surfaces.

U.S. Pat. No. 5,231,156 issued Jul. 27, 1993 to Lin provided an organic-inorganic hybrid polymer comprising the reaction product.

5 to 25 percent by weight of an organofunctional alkoxy silane up the general formula are 95 to 75 percent by weight of an organic monomer capable of reaction with the organofunctional and polymerization, alkoxysilane hydrolyzes and condenses to form the inorganic polymer portion and the organic monomer reacts to what the organofunctional radical and further polymerizes to form the organic polymer portion of the organic-inorganic hybrid polymer.

U.S. Pat. No. 5,868,966 issued Feb. 9, 1999 to We et al. provided by hybrid materials which were formed having a homogenous distrbution of a conductive organic polymer or copolymer in an inorganic matrix. The conductive organic polymer may be electronically conductive, e.g., poyaniline, or way be ionically conductive, e.g., sulfonated polystyrene. The inorganic matrix is formed as a result of sol-gel chemistry, e.g., by the hydrolysis and condensation of tetraethyl orthosilicate and trialkoxysilyl groups in the organic polymers. A homogenous distribution of organic polymer in the inorganic matrix is achieved by preparing separate solutions of organic polymer and homogenous clear solution. Upon evaporation of the solvent and other volatiles, a monolithic hybrid material may be formed. The combination of conductive organic polymer in an inorganic matrix provides desirable adhesion properties to an inorganic substrate while maintaining the conductivity of the organic polymer. The term organic inorganic hybrid materials embrace two types of hybrids. In the firs, covalent bonding occurs between an organic polymer and an inorganic matrix, and such hybrids will be referred to as covalent hybrids. An oxygen atom, which is commonly found in both organic polymers and inorganic matrices, is typically employed to link the organic and inorganic components of the covalent hybrid. In a second type of hybrid, the organic polymer and inorganic matrix are intimately mixed together, i.e., the organic polymer uniformly dispersed throughout and inorganic matrix, or vice versa. The second type of hybrid, which does not contain a covalent bond between organic and inorganic components, will be referred to as dispersion hybrids. Covalent and dispersion hybrids are to be distinguished from conventional composite materials arm from organic and inorganic materials, with conventional composite materials have microscopic interfaces.

The development of sol-gel chemistry, which occurred during the past two decades has provided a convenient entry into the organic matrices of hybrid materials.

U.S. Pat. No. 5,973,176 issued Oct. 26, 1999 to Roscher et al. provided organically modified silanes which are hydrolysable, which by themselves, in mixtures or together with other hydrolyzable and/or condensable compounds may be processed into scratch-proof coatings, fillers, adhesives or caulking compounds, into formed articles or imbedding materials. The silanes are to be universally applicable, and they are to be incorporable into an organic-organic compound system, i.e. an inorganic-organic network. Furthermore, the silanes by themselves, in mixtures or together with other hydrolyzable and/or condensable compounds to yield hetero silicic acid polycondensates of good adhesive and U.S. Pat. No. 5,412,043, issued May 2, 1993 to Novak et al. provided an inorganic-organic composite material having a solid interwoven of an inorganic polymer matrix with interpentratng polymerized alcohols in which the organic matrix can be baeed on either Si or Ti atoms, which can be prepared by way of sol-gel procedure. The sol-gel reaction is a two-step process during which metal alkoxides are hydrolyzed to form metal hydroxides, which in turn condense to form a three-dimensional network. The sol-gel products of inorganic components are generally to produce hard and brittle glass. Sol-el method allows the formation of hybrid composite materials made of inorganic (glass) and organic components which would not survive the very high temperatures of glass making methods. Such a composite material can provide advantages resulting from the combination of tensile strength and impact resistance of the organic polymer and compression strength of the inorganic matrix. The introduction of organic groups into glass can thus provide variations in properties such as strength, toughness, stiffness, brittleness, hardness, homogeneity, density, three volume, and thermal stability. Secondary considerations include resistance to corrosion, creep, and moisture. Both the strength and stiffness of a composite can be derived from properties of the reinforcing fiber. Toughness results from the interaction between the matrix and the fibers. Such composite materials may be used in the manufacture of piezoelectric, ferroelectric, electro-optic, and superconducting fibers.

U.S. Pat. No. 5,631,331 issued May 20 at 1997 to Sakamara et al. provided organic-inorganic hybrid polymer having a structure of organic polymers bonded through siloxane linkages, sometimes called “ormosil” or “creamer”, has excellent properties including high mechanical strength, high heat resistance, flame retardancy, light-fastness and so on so that polymers of this type are promising and under extensive development works a constituent of coating compositions, material of structural members for high-temperature service and the like. The properties of these organic-inorganic hybrid polymers are intermediate of organic polymers, i.e. plastic resins, and inorganic materials, i.e. glass and ceramics, so that the application fields thereof are expected to cover those in which satifactory performance can be exhibited by none of the conventional organic materials and inorganic materials as well as mere combinations thereof.

This patent provided a novel and improved method for the industrial preparation of a silicon-containing polymer having a structure of organic polymers bonded through siloxane linkages and exiting excellent heat resistance in a simple and convenient process by using an inexpensive starting material of good availability. temperature properties and good optical attenuation values so that these hereto silicic acid polycondensates are suitable for optical or opto-electronics.

U.S. Pat. No. 6,005,028 issued Dec. 21, 1999 to Paul, provided alkoxides with polymerizable groups are single source precursors for organic-inorganic hybrid composites possessing good mechanical properties. Additional function groups of the alkoxides provide enhanced adhesion to other surf such as dentin. The selection of specific organic monomers having functional groups that are responsible for enhances properties of the organic-inorganic hybrid composites is important. Single source precursor containing the desired functional groups are condensed and polymerized into the organic-inorganic hybrid composites with enhanced properties.

U.S. Pat. No. 6,066,269 issued May 23, 2000 to Wer et al. provided hybrid materials which were formed having a homogenous distribution of a conductive organic polymer or copolymer in an inorganic matrix. The conductive organic polymer may be electronically conductive, e.g, polyaniline, or may be ionically conductive, e.g., sulfonated polystyrene. The inorganic matrix is formed as a result of sol-gel chemistry, e.g., by the hydrolysis and condensation of tetraehyl orthosilicate and trialkoxysilyl groups in the organic polymers. A homogenous distribution or organic polymer in the inorganic matrix is achieved by preparing separate solutions of organic polymer and sol-gel monomer, and then combining those solutions with a catalyst and stirring, to form a homogenous clear solution. Upon evaporation of the solvent and other volatiles, a monolithic hybrid material my be formed. The combination of conductive organic polymer in an inorganic matrix provides desirable adhesion properties to an inorganic substrate while maintaining the conductivity of the organic polymer.

These inorganic organic hybrids are the reaction product of hybrid forming components including organic polymer, sol-gel monomer, catalyst and solvent, where the solvent is preferably aqueous. The solvent provides for a homogenous distribution of organic polymer and sol-gel monomer in a solution, and thus the resulting hybrid material will likewise have a homogenous distribution of organic polymer in the inorganic matrix that forms from the sol-gel monomer. The catalyst is present to promote the hydrolysis and condensation chemistry that is necessary to convert the sol-gel monomer into the morganic matrix. The sol-gel monomer reacts with itself to form an inorganic matrix, which because it typically has a high glass transition temperature, is also referred to as a glass or inorganic glass. The organic polymer either has functionality that imbues with conductive properties, for example electronically or ionically conductive properties, or has a structure that may react and thereby be converted to an organic polymer having conductive properties. In a preferred embodiment, the organic polymer comprises functional groups that react with the sol-gel monomer, so that covalent bonding is formed between the organic polymer and the inorganic matrix.

U.S. Pat. No. 6,103,854 issued Aug. 15, 2000 to Arakawa et al. provided an organic-inorganic hybrid polymer material obtained by the process in which a polymer having a polycarbonate and/or a polyarylate moiety as a main frame, a metal alkoxide group as a functional group, a number average molecular weight of from 500 to 50000 as measured by GPC, and a metal alkoxide group equivalent weight of form 1 to 100, is hydrolyzed and polycondensed to form crosslinkages wherein the organic-inorganic hybrid polymer material has high heat resisiance mechanical strength, water resistance and surface hardiness.

U.S. Pat. No. 6,117,498 issued Sep. 123, 2000 to Chondroudis et al. provided a method of forming a film of an organic-inorganic hybrid material in a selected stoichiometric ratio upon a surface of substrate, the proposed method entails a number of simple steps. First, a subrate and a selected quantity of an organic-inorganic hybrid material are placed in a chamber, with the hybrid material being placed on a heater. Then, the hybrid material is heated sufficiently, as by passing an electric current through the heater, to cause its total ablation. As a consequence, a film of the organic-inorganic hybrid material, in the aforesaid selected stoichiometric ratio, reassembles as a film upon a surface of a substrate.

### SUMMARY OF THE INVENTION

### AIMS OF THE INVENTION

An object of the present invention is to provide an organic-inorganic hybrid macromolecular surface adhesion promoter that, in addition to the advantage of regular macromolecular surface adhesion promoter, can be easily designed and synthesized, is thermally very stable, have the physical properties falling between those of organic polymer and inorganic materials.

Organic-inorganic hybrids are a new class of materials developed to fill the gap between organic polymers and inorganic materials, such as ceramics. Generally, there are two types of organic-inorganic hybrids in terms of interaction: those without covalent bonding but with good compatibility and strong physical interaction between organic part and inorganic part and those with covalent bonding between the two phases. In the hybrids, the organic part is phase separated from the inorganic part, and the phase domain for each phase is in nanometer scale. Consequently, the hybrids are also called nano-composites. Organic-inorganic hybrids are usually synthesized by sol-gel process and the materials have been used as wear resistant coating, films, bulk materials, matrix for fibre composites, waveguides, and other applications.

### STATEMENT OF THE INNENTION

In general terms, the present invention provides a surface adhesion promoter in the form of an organic-inorganic hybrid whose moleceles are composed of organic part on one end and inorganic chains on the other end, with the organic part chemically connected inorganic part by covalent bonds. In general terms

The organic part has good compatibility and can even react with organic materials which may be applied there were. The inorganic part can react with the substrates to form Si—O—Si M-O-M, M-O—Si, or Si—O-M (where, M stands for metal atom) connection

The organic part generally conssts of highly branched or lowly crosslinked network with some organic end groups hanging outside the network. The inorganic part generally includes a hydroxide end functional group. The inorganic part is also highly branched or lowly crosslinked.

The promoter is synthesized by sol-gel process. This strategy is to synthesize the organic part first and then connect inorganic part to the organic part by chemical reaction.

### OTHER FEATURES OF THE INVENTION

The adhesion promoter can be easily designed, synthesized and processed. In addition to its adhesion promotion function, the promoter can also act as a transit interlayer between substrate and top layer of polymer.

### GENERALIZED DESCRIPTION OF THE INVENTION

The surface promoter is synthesized by first hydrolyzing and polycondensing a trioxysilane (R—Si(OR′)₃) or its mixture with another one or two silanes with acid or base as catalyst, where R is an organic group which has similar chemical structure to the organic materials to be applied on top and/or can chemically react with the materials to form covalent bonding, and R′ is methyl, ethyl, and propyl.

If epoxy is to be applied thereover, the silane could be [3-(glycidyloxy) propyl] trimethyloxysilane. The 3-(glycidyloxy) propyl has a good compatibility with epoxy and can react with epoxy resin, coating, or adhesives to form strong covalent bonds.

If polytetrafluroethylene (PTFE) is to be applied thereover as a coating, the silane could be (tridecafluro-1,1,2,2-tetrahydro-oetyl) triimethyloxysilane.

If the organic material to be applied is a coating contains two distinct chain units, another one or two silanes are needed. For, instance, if unsaturated polyester resin is going to be applied, 10-15% diphenyldimethoxysilane could be added in two methacryloxypropyltrimethoxysilane for co-poly condensation. While methacryloxypropyl can react with the double bonds in unsaturated polyester, the diphenyl groups improve the compatibility between the surface promoter with the resin.

In order fully to hydrolyze the silanes, extra water is usually added. H₂O can be used for all kinds of applications, except for the application in optical telecommuncaton because O—H bond has a very strong absorption between 1.3 and 1.55 μm wavelength, both of which are the communication working wavelength. In this circumstance, deuterium dioxide D₂O, instead of H₂O, can be applied.

Inorganic acids, e.g., HCl and H₂SO₄, and organic acids, eg., acetic acid are ideal acid catalysts while inorganic bases, e.g., NAOH, and organic bases, e.g., NEt₄OH are ideal base catalyst. pH of 2-5 for an acid-catalyzed reaction and pH 8-11 for base catalyzed reaction are the desired levels. The reaction can be carried out in bulk, i.e. in the absence of a solvent, or in solvent. Organics, solvents, e.g., MeOH, EtOH, THF, and Acetone, are all suitable solvents for the reaction.

Experimentally, the reaction is started with charging silanes into a two necks or a three necks flasks and adding certain amount of acid or base so that the desired pH value can be met. After connecting a flux tube to the flask, water with 1.05-1.20 times of the theoretical amount is added into the flask during stirring, followed by bring the mixture to the desired temperature. Reaction could be carried out at room temperature to 110° C. In case a solvent is used, the boiling point of the solvent is a good reaction temperature. 65° C., for example, can be the reaction temperature when MeOH is used as solvent. Simply, the heater is adjusted so that the solvent is boiled and refluxed during the reaction. Reaction time is 5-24 hrs, depending on the catalyst and reaction temperature. Base and high reaction temperatue are both in favor of reaction kinetics, thus, short reaction.

When the reaction reaches a certain degree and the product is viscous if all the solvent and byproducts are removed, 5-30% of another silane or metal alkoxides are gradually added into the solution for co-polycondensation. Tetramethoxysilane and tetraethoxysilane are typical silanes used for synthesizing silicon containing surface adhesion promoter, and the metal alkoxides with long chain alkyl-groups are suitable for synthesizing metal containing promoter. Aluminum butoxide, zirconium propoxide, titanium butoxide, and zirconium butoxide are the examples of suitable metal alkoxides.

The selection of silane or metal oxides depends on the substrate to be worked on. When the substrate is glass, silica or silicon, silane, such as tetramethoxysilane and tetraethoxysilane, is chosen. This step of reaction is to connect inorganic part to the synthesized inorganic part. When the substrate is a metal like aluminum, for instance, alminum butoxide can be selected. If the thermal expansion mismatch between the organic materials and substrate is insignificant, the selection of siline and metal alkoxides is not critical and the silane and metal alkoxides could be inter-replaceable.

Before adding the above silane or metal alkoxides, a solvent should be added into the solution to reach a ratio of solvent to raw chemicals of 0.5:1 to 3:1. After stirring for 2-7 hrs, water, with theoretically required amount for the silane or metal alkoxides, is added into the solution to fully hydrolyze the silane or metal alkoxides. The resulted solution is then aged at room temperature for 24 hrs or longer before it is ready for use. Some H—O—Si or H—O-M end groups will be left in the promoter and will be the important function groups reacting with substrates.

After the aging, the obtained surface adhesion promoter is diluted with a solvent which is the same as that added during the reaction, and may be directly applied on the substrate, e.g., silica, glass, silicon wafer, aluminum, by dipping coating, spinning coating, or spraying, depending on the quality requirement. If the top organic material is going to be deposited as high quality film or coating for instance, dipping coating and spinning coating are suitable technologies for applying the promoter. The preferred thickness for the promoter is 0.2 to 3 μm. A thermal treatment at 90-150° C. is required to enhance the reaction between the promoter and the substrate. Si—O—Si M-O—Si, Si—O-M, or M-O-M bonds can be formed between the promoter and substrate. When the treatment is completed, the top organic materials can be applied.

The inorganic matrix of the inorganic organic hybrid materials of the invention is prepared using sol-gel chemistry. Monomers that may be employed in sol-gel chemistry numerous and well-known in the art, and are referred to herein as sol-gel monomers. Any of the monomers that are conventionally employed to prepare an inorganic marix by way of sol-gel chemistry, may also be employed to prepare the inorganic matrix of the inorganic organic hybrid materials of the invention. Exemplary sol-gel monomers include, without limitation, tetraethyl orthosilicate (TEOS), titanium tetraisopropoxide (TIPO), aluminum tri-sec-butoxide (ASBO), silicon tetrachloride, titanium tetrabutoxide, titanium(IV) bis(ethyl acetate) silicon(IV) aceate, silicon(IV) acetylacetonate, triethoxyhydrosilane, hexachlorodisiloxane, titanium(IV) ethoxide, titanum(IV) butoxide, titanium(IV) chloride, titanium(IV) 2-ethylhexoxide, titanium(IV) oxide acetylacetonate, titanium diisopropoxide bis(2,4-pentanedionate), titanium(IV), (triethanolaminato)isopropoxide, zirconium(IV) tert-butoxide, zirconium (IV) acetylacetonate, zirconium (IV) ethoxide, rubidium acetylacetonate, ruthenium (III) acetylacetonate, niobium(IV) ethoxide, vanadium (IV) oxytriethoxide, tungsten hexaethoxide, etc.

### DESCRIPTION OF PREFERRED EMBODIMENTS

The following are examples of preferred embodiments of the invention.

### EXAMPLE 1

30 g of 3-(trimethoxysilyl)propyl methacrylate (TMSPM) was charged into a 250 ml three necks flask. After adding small amount of 37% HCl as catalyst, 6.7 g H₂O was gradually dropped into the solution during magnetic stirring. The reaction was kept at 65 to 70° C. for 7 hrs. The solution was then cooled down to room temperature, followed by the addition of 30 ml ethanol and 2.5 g tetraethoxysilane (TEOS). The solution was stirred for 3 hrs at room temperature. Afterwards, 1 g H₂O was added into the solution. After 24 hrs stirring, the solution was ready for use.

The surface adhesion promoter was applied on silicon wafer and glass to help the processing of various methacrylate containing polymers and sol-gel materials, and promote the adhesion between the materials and substrate. High surface quality and good adhesion was achieved when the surface adhesion promoter was applied in processing some methacrylate containing organic waveguide materials.

### EXAMPLE 2

15 g of 3-(trimethoxysilyl)propyl methacrylate (TMSPM) and 10 g of diphenydiethoxysilane (DPDES) were charged into a 250 ml three necks flask and mixed. After adding small amount of 37% HCl as catalyst, 6.3 g of D₂O (deuterium dioxide) was gradually added into the mixture. The reaction was kept at 58° C. for 7 hrs. Then, 50 ml acetone was added into the solution at room temperature, followed by 2 g of tetraethoxysilane (TEOS). 4 hrs later, 1 g of D₂O was gradually into the solution and the solution was kept stirring at room temperature for 24 hr.

The surface adhesion promoter was applied on silicon wafer, silica and glasses to help the processing and promote adhesion of the sol-gel waveguides synthesized from TMSPS and DEDES. The surface roughness of the undercladding and core were achieved at 0.1 μm after applying the promoter, which is difficult for thick sol-gel coatings. Also, no any delamination was observed after the waveguides were exposed to thermal cycle from room temperature to 170° C. and mechanical cut, i.e. dicing, and the cleaning with water and compressed air.

### EXAMPLE 3

30 g of 3-glycidoxypropyltrimethoxysilane (GPTMS) and 20 ml were charged into a 250 ml three necks flask and mixed. After tetramethylammonium hydroxide (TMAH) as catalysts 7.2 g of H₂O was gradually added into the mixture. The reaction was kept at 50-65° C. for 5 hrs. Then, 20 ml ethanol was added into the solution at room temperature, followed by adding 4 g of aluminum butoxide. After being stirred for 4 hrs, 1 g of H₂O was gradually into the solution and the solution was kept stirring at room temeature for 20 hr.

The surface adhesion promoter was applied on silicon wafer, aluminum and glasses to help the processing and promote adhesion of epoxy resin.

### EXAMPLE 4

17.5 g of vinyl-triethoxysilane (VTES) and 12.5 g of diphenydiethoxysilane (DPDES) were charged into a 250 ml three necks flask and mixed. HCl was used as catalyst and 6.8 g of H₂O was used for hydrolysis. The reaction temperature and time were 80° C. and 9 hrs, respectively. Ethanol was used to dilute the solution before 5 g TEOS was added for polycondensation. Additional water of 2 g was used to fully hydrolyze residual TEOS and the resulted solution was aged, while kept stirring, at room temperature for 24 hrs. before being applied on glasses and silicone.

### CONCLUSION

The surface adhesion promoter of the pressnt invention has many advantages, including all the advantages for macromolecular surface adhesion promoter as described above, the benefits from organic-inorganic hybrids, and the simplicity in molecular store design and synthesis. Since all the chemicals used for synthesizing the surface adhesion promoters have very good market availability, the production cost is also lower. Its application can be used in the areas that regular small molecular surface adhesion promoters are used, and can be also used as specialty surface adhesion promoter in the area where high performance is required. Ductile fibre-resin interface in high performance composites used in aerospace, and thermal expansion transition interface in organic waveguides on silicon wafer are two examples.

The application in fabricating organic waveguides is the most preferred area for the organic-inorganic hybrid surface adhesion promoter because the materials are very difficult in processing, while very high quality is required for the products. Organic materials, especially, have to be fluorinated in order to reduce their optical loss at the communication wavelength, such as 1550 nm and 1300 nm. Fluorinated materials have low surface energy and poor wetability and adhesion with silicon and silica, which are the common substrates for fabricating waveguides, easily, resulting in rough surface and delimitation. Waveguides are manufactured by coating organic materials layer by layer on highly polished silicon and silica. The surface roughness of under cladding and core has to be controlled to very low lever to reduce propagation loss. It is extremely difficult to achieve such high surface quality coatings by depositing low surfrce energy materials on high surface energy substrates. Also, waveguide fabrication process usually experiences some high temperature, over 200° C. for polyamide, for instance, and the fabricated waveguide samples will experience cutting and other tough post process for package. Delamination could easily occur during the processes if the adhesion is not good enough, and if there is no stress relaxation and thermal expansion transition mechanism at the interface. It was the initial tendency of this invention to develop a surface adhesion promoter and apply it in fabricating organic waveguides.

Thus, by the present invention, a series of silicon containing and metal containing organic-inorganic hybrids have been developed for promoting the adhesion between hydrophilic substrates, e.g silicon wafer, silicate, glass, metal oxide, ceremics, and metals, with sol-gel and polymer coatings, adhesives, and bulks. The hybrids consist of hydrophilic Si—O—Si or M-O-M inorganic network, where M stands for metal atoms, e.g., Al, Ti Zr, and Er, and hydrophobic organic sectors. There are chemical bonds between the inorganic and organic parts. It is flexible to design and prepare the hybrids according to the nature of the substrates, and the coatings, adhesives, or bulks to be applied on the substrates. The methodology is to connect hydrophilic inorganic parts, by a sol-gel process, with hydrophobic organic groups, identical or similar to those in the coatings to be applied. The former part provides a good adhesion with substrates while the later one provides the wetting and adhesion with the materials to be applied. Since the surface promoter is macromolecular, it serves as a transition layer between inorganic substrate and the materials to be applied. The hybrids can be easily applied on the substes prior to the coatings, adhesives, or bulks to be applied. Such hybrid adhesion promoter can also significantly improve the processability and quality of the coatings which are inert to hydrophilic substrates. Organic waveguide fabrication is the most preferred application of the surface adhesion promoter. Exemplary acrylate and methacrylate monomers that may be used in this invention include, without limitation, 3-(trimethoxysilyl)propyl methacrylate, 3-triethoxysilyl)propyl methacrylate (ESMA), methacryloxypropyltris(pentamethyldisiloxanyl)silane, 3-acryloxypropyldimethylmethoxysilane, N-(3-acryloxy-2-hydroxypropyl)3-aminopropyltriethoxysilane, 3-acryloxpropyltrimethoxysilane, 3-acryloxypropyltrichlorosilane, 2-methacryloxyethyldimethyl-3-trimethoxysilyl propylammonium chloride, 3-methacryloxypropyltris(methoxyethoxy)silane, methacrylozypropenyltrimethoxysilane, 3-methacryloxypropylmethyldiethoxysilane and methacryloxypropylmethyldichlorosilane.

Exemplary shyrene and styrene derivatives that may be employed on this invention include, without limiteation, styrylethyltimethoxysilane (STMS), styrylethyltriethoxysilane, syrylethyltriechlorosilane, styrylpropyltrimethoxysilane and styrylpropyldimethylethoxysilane.

Examples of alkoxy silane compounds used in the present invention include:

1. 3-Trimethoxysilyl)propyl methacrylate

2. 3-Glycidoxypropyltrimethoxysilane

3. 3-Aminopropyltrimethoxysilane

4. 3, 3, 3-Trifluoropropyl-trimethoxysilane

5. 2-(3,4-Epoxycyclohexyl)ethyl-trimethoxysilane

6. gamma-Methacryloxypropyltrimethoxysilane

7. Isobutyl-trimethoxysilane

8. (3-Bromopropyl)trimethoxysilane

9. (3-Mercaptopropyl)trimethoxysilane

10. Phenyltrimethoxysilane

11. Vinyltrimethoxysilane

12. (3-Glycidyloxypropyl)triethoxysilane

13. 3-Aminopropyltriethoxysilane

From the forgoing description one skilled I the art can easily ascertain the essential characteristics of this invention, and without departing from the spirit and scope thereof, can make various changes and modifications of the invention to adapt it to various usages and conditions. Consequently, such changes and modifications are properly, equitably, and “intended” to be, within the fill range of equivalence of the following claims.

What is claimed is:

1. An organic-inorganic hybrid surface adhesion promoter having the general formula:
A-B;
wherein A is hydrolyzed and polycondensed from a trioxysilane R—Si(OR′)₃ or its mixture with one or two more silanes, where R′ is methyl, ethyl or propyl, and where R is an organic group of methacrylate, epoxy, amine, isolyante, hydroxide or non-halogens or halogens containing alkyl, alkenyl, aryl, alkylary or arylalky; and
wherein B is hydrolyzed and polycondensed from an alkoxy silane, chloride silane, or alkoxy or chloride metal compound, whereby B reacts with a substrate to form a uniting group which is selected from the group consisting of:
Si—O—Si
M-O-M
M-O-S and
Si—O-M,
M being a metal atom.

2. The organic-inorganic hybrid surface adhesion promoter of claim 1 wherein the organic molecule comprises a methylidene monomer.

3. The adhesion promoter of claim 2 where said methylidene monomer comprises acrylates, methacrylates, styrene derivatives, 1-olefins or vinyl molecules.

4. The adhesion promoter of claim 3 wherein said acrylate or methacrylate comprises 3-(trimethoxysilyl)propl methacrylate, 3-(triethoxysilyl)propyl methacrylate (ESMA), methacryloxypropyltrispentamethyldisiloxanyl)silane, 3-acryloxypropyldimethylmethoxysilane, N-(3-acryloxy-2-hydroxypropyl)-3-aminopropyltriethoxysilane, 3-acryloxpropyltrimethoxysilane, 3-acryloxypropyltrichlorosilane, 2-methacryloxyethyldimethyl-3-trimethoxysilyl propyl ammonium chloride, 3-methacryloxypropyltris(methoxyethoxy)silane, methacrylozypropenyltrimethoxysilane, 3-methacryloxypropylmethyldiethoxysilane and methacryloxypropylmethyldichlorosilane.

5. The adhesion promoter of claim 3 wherein said styrene or styrene derivates comprise include styrylethyltrimethoxysiiane (STMS), styrylethyltriethoxysilane, stryrylethyltrichlorosilane, styrylpropyltimethoxysilane or styrylpropyldimethylethoxysilane.

6. The adhesion promoter of claim 3 wherein said 1-olefin and vinyl comprises vinyltriethoxysilane, vinyltrimethoxysilane, allyltrimethoxysilane, vinyltriphenoxysilane, vinyl-tert-butoxysilane, vinyltrichlorosilane, vinyltiisopropenoxysilane, vinyltris(2-methoxyethoxy)silane, vinyltris(methylethylketoximine)silane, 1-vinyldmethylethoxysilane, vinylmethydichlorosilane, vinyldiethylchlorosilane, (N-3-trimethoxysilylpropyl)N-methyl-N, N-diallylamonium chloride, tetraallyloxysilane and diisopropenoxydimethylsilane.

7. The surfice adhesion promoter of chaim 1 wherein the organic compound is 3-(trimethoxysilyl) propyl methacrylate.

8. The organic-inorganic hybrid surface adhesion promoter of claim 1 wherein said silane is a trioxysilane of the formula R—Si(OR′)₃ wherein R is an alkyl group.

9. The surface adhesion promoter of claim 8 wherein said alkyl group is methyl, ethyl or propyl.

10. The surface adhesion promoter of claim 1 wherein said inorganic molecule is low molecular weight alkoxy silane compound selected from the group consisting of aminopropyl triethoxysilane, aminopropyl triethoxysilane, and aminoethylaminopropyl triethoxysilane.

11. The surface adhesion promoter of claim 10 wherein the alkoxy silane compound is aminopropyl triethoxysilane.

12. The surface adhesion promoter of claim 1 wherein the silane is diphenl ethoxysilane.

13. The surface adhesion promote of claim 1 wherein the silane is tetraethoxysilane.

14. The surface adhesion promoter of claim 1 wherein the silane is tetramethoxysilane.

15. The surface adhesion promoter of claim 1 wherein the silane is [3-(glycidyloxy)propyl]trimethoxysilane.

16. The surface adhesion promoter of claim 1 wherein the silane a tridecafluoro-1, 1, 2, 2-tetra hydro-octyl)triethoxysilane.

17. The surface adhesion promoter of claim 1 wherein the silane a diphenyldimethoxysilane.

18. The surface adhesion promoter of claim 1 wherein the silane is methacryloxy propyl trimethoxysilane.

19. The surface adhesion promoter of claim 1 wherein to silane is vinyltriethoxysilane.

20. A process for preparing an organic-inorganic hybrid surface adhesion promoter, comprising the steps of:
(a) hydrolyzing and polycondensation, a polymerizable organic monomer with at least one of a siloxane and a mixture of a siloxane with at least one other silane, in the presence of an acid or a base as catalyst; and
(b) co-polymerizing the product of (a) with at least one of a silane and a metal alkoxide.

21. The process of claim 20 carried out in the presence of an acid or a base catalyst.

22. The process of claim 20 wherein the catalyst is an inorganic acid.

23. The process of claim 22 wherein the inorganic acid is HCl or H₂SO₄

24. The process of claim 20 wherein the catalyst is an organic acid.

25. The process of claim 24 wherein the organic acid is acetic acid.

26. The process of claim 20 wherein the catalyst is an inorganic base.

27. The process of claim 26 wherein the inorganic base is NₐOH.

28. The process of claim 20 wherein the catalyst is an organic base.

29. The process of claim 28 wherein the organic base is NE—₄OH.

30. The process of claim 20 wherein the reaction is carried out at a pH of 2 to 5.

31. The process of claim 20 wherein the reactor is carried out at a pH of 8 to 11.

32. The process of claim 20 which is carried out in the presence of a solvent.

33. The process of claim 32 wherein the solvent is methanol, ethanol tetrohydrofuron or acetone.

34. The process of claim 20 which is carried out in the presence of additional water.

35. The process of claim 20 comprising the additional steps of co-poly condensation in the presence of an added silane.

36. The process of claim 35 wherein the added silane is tetramethoxysilane or tetraethoxysilane.

37. The process of claim 20 comprising the additional steps of co-polycondensation in the presence of added metal alkoxide.

38. The process of claim 37 wherein the metal alkoxide is aluminum butoxide, zirconium propoxide, titanium butoxide or zirconium butoxide

39. The process of claim 20 comprising reacting 3-trimethoxysilyl) propyl methacrylate in the presence of HCL as a catlyst and excess water at an elevated temperature; adding ethanol an tetraethoxysilane and water; and recovering the adhesion promoter so formed.

40. The process of claim 20 comprising reacting 3(trimethoxysilylpropyl) methacrylate and diphenyldiethoxy silane in the presence of HCI as a catalyst and excess D₂O; at an elevated temperature adding acetone or tetraethoxysilane and D₂O; and recovering the adhesion promoter so formed.

41. The process of claim 20 comprising reaching 3-(trimethoxysilyl)propyl methacrylate (TMSDM) and diphenyldiethoxysilane in the presence of tetramethylammonium hydroxide as catalyst and excess water at elevated temperature; adding aluminum butoxide and water; and recovering the adhesion promoter so-formed.

42. The process of claim 20 comprising reacting vinyl triethoxysilane and diphenyldiethoxy silane in the presence of HCL as a catalyst and excess water at elevated temperatures; adding ethanol and tetraethoxysilane and additional water; and recovering the adhesion promoter so formed.

43. The use of the surface adhesion promoter of claim 1 for improving adhesion between an organic material and an inorganic material.

44. The use as claimed in claim 43 for promoting adhesion to methacrylate-containing organic waveguide materials.

45. The use as claimed in claim 43 for promoting the adhesion on a silicon wafer on silicon or glass or glass to promote adhesion to a sol-gel waveguide which is formed of organic materials.

46. The use as claimed in claim 43 for promoting the adhesion of an epoxy resin onto silicon wafer, or aluminum or glass.
